(19) United States
(12) Patent Application Publication
(10) Pub. No.: US 2016/0063898 A1
(43) Pub. Date: Mar. 3, 2016

(54) OPHTHALMIC SURGICAL SIMULATION SYSTEM

(71) Applicant: BIONIKO Consulting LLC, Sunny Isles Beach, FL (US)

(72) Inventor: Andres BERNAL, Sunny Isles Beach, FL (US)

(21) Appl. No.: 14/468,769

(22) Filed: Aug. 26, 2014

(51) Int. Cl. G09B 23/32; G09B 23/30; G09B 23/34

(52) U.S. Cl. CPC G09B 23/32; G09B 23/34; G09B 23/306

(57) ABSTRACT

An eye model system includes a socket housing having an interior cavity sized to receive an eye model, and an anterior opening communicating with the interior cavity. Engagement structure is provided for detachably engaging and securing the eye model in the interior cavity. A method for practicing medical procedures is also disclosed.

### FIELD OF THE INVENTION

This invention relates generally to anatomical models, and more particularly to anatomical models for the practice of surgical and other medical procedures.

### BACKGROUND OF THE INVENTION

Currently, ophthalmic research and surgical education relies heavily on practice and testing on explanted human cadaver/donor eyes and explanted animal eyes, with special focus on porcine, primate, rodent (rabbit) and human cadaver eyes.

“Wet-lab” is the name given to ophthalmic training events where students practice techniques with explanted eyes. Explanted eyes come usually in a vial with remnants of ocular muscles and the optic nerve. Explanted eyes are covered in a mucous membrane called the conjunctiva which makes them slippery, and with the fact that they are spherical, makes them difficult to handle, fix and stabilize to perform and practice a surgical procedure.

Students usually wrap explanted eyes in paper towels or make nests with gauze or other materials to stabilize the eye, or are provided with Styrofoam mannequins and the eye is pinned or sutured to the foam. The eye is relatively free to move, however, and incisions and other puncturing procedures are difficult. This training environment adds complications to the training exercise that are not present at the time of surgery. Also, because the eyes are explanted the facial features and other anatomical structures around the eye are absent which sometimes detracts from the realism of the training procedure.

In addition, explanted eyes usually have low IOP (Intra ocular pressure). This means they are “flaccid” and therefore lose form and realism for purposes of practicing surgery. To overcome this, explanted eyes have to be injected with saline, or compressed manually so the eye regains rigidity.

### SUMMARY OF THE INVENTION

An eye model system includes an eye model having a posterior segment and an anterior segment. The anterior segment and the posterior segment are detachably connectable. The posterior segment includes an elongated connector having a posterior end. A base is attached to the posterior end of the elongated connector. A socket housing has an interior cavity sized to receive the eye model, an anterior opening communicating with the interior cavity, and cooperating engagement structure for engaging the base.

The socket housing can include a receptacle. The base and the receptacle can mate to secure the posterior segment to the socket housing.

The posterior segment can have structure for receiving a portion of the anterior segment. The posterior segment can include a semispherical receptacle having an anterior opening for receiving the anterior segment. The anterior segment can be a biological eye that can be placed into the receptacle.

At least the anterior segment of the eye model can be synthetic. At least the anterior segment of the eye model is biological.

The socket housing can include fluid port openings. A detachable cover can be provided for engaging the socket housing and retaining the eye model within the interior cavity. An anterior portion of the socket housing can include a simulation of at least one selected from the group consisting of the frontal bone, the nasal bone, the maxilla bone and the zygomatic bone.

The socket housing can include a flexible material, which will yield under manual force. The elongated connector can be flexible, whereby the posterior segment will yield under manual force.

The eye model system can include structure for applying an adjustable force to the eye model, so as to adjust the intra ocular pressure within the eye model. A sensor can be provided for sensing the intra ocular pressure.

The eye model system can include structure for engaging the socket housing to a support surface. The structure for engaging the support surface can include a flexible portion for permitting tilting of the socket housing relative to the support surface.

The socket housing can include a transparent portion for viewing a medical procedure as it is practiced. The socket housing can include lighting for illuminating the eye model.

A method for practicing medical procedures of the eye can include the step of providing an eye model system including a socket housing having an interior cavity sized to receive an eye model, an anterior opening communicating with the interior cavity, and engagement structure for detachably engaging and securing the eye model in the interior cavity. An eye model can be provided and positioned within the interior cavity. The medical procedure is then practiced.

The method can include using the eye model engagement structure to adjustably position the eye model in three dimensions within the interior cavity. The eye model can include at least one anterior segment and at least one posterior segment, and the method can include the step of engaging the anterior segment to the posterior segment. The eye model can include a plurality of anterior segments, and the method can include the steps of selecting a medical procedure that will be practiced and selecting the anterior segment from the plurality based upon the medical procedure that is selected. The selected anterior segment is then engaged to the posterior segment.

The method can include the step of sensing the intra ocular pressure of the eye model, and applying a force to the eye model to adjust the intra ocular pressure. The force can be applied by the eye model engagement structure.

A socket housing for securing an eye model includes an interior cavity sized to receive an eye model, and an anterior opening communicating with the interior cavity. Engagement structure is provided for detachably engaging and securing the eye model in the interior cavity. A flexible portion permits the engagement structure to move upon the application of a force to the eye model.

The eye model engagement structure can be attached to a rigid portion of the socket housing. The rigid portion communicates with the flexible portion such that a force on the engagement structure will be transmitted to the rigid portion and thereby to the flexible portion, causing the flexible portion and thereby the rigid portion and the engagement structure to yield under the force.

The eye model engagement structure can be laterally adjustable. The eye model engagement structure can include laterally adjustable elongated members circumferentially distributed about the interior cavity of the socket housing. The eye model engagement structure can adjustably position the eye model in three dimensions within the interior cavity. The engagement structure can include anterior laterally adjustable engagement structure and posterior laterally adjustable engagement structure.

The socket housing can further include an eye model. The eye model can have a posterior segment and an anterior segment. The posterior segment and the socket housing can have cooperating engagement structure for engaging the posterior segment to the socket housing.

A socket housing for an eye model can include an interior cavity sized to receive the eye model and an anterior opening communicating with the interior cavity, and laterally adjustable eye model engagement structure for detachably engaging and securing the eye model in the interior cavity. The engagement structure can include posterior engagement structure for limiting posterior movement of the eye model, and anterior engagement structure for limiting anterior movement of the eye model. The eye model engagement structure can include laterally adjustable elongated members circumferentially distributed about the interior cavity of the socket housing. The eye model engagement structure can adjustably position the eye model in three dimensions within the interior cavity. The eye model engagement structure can include anterior laterally adjustable engagement structure and posterior laterally adjustable engagement structure.

The socket housing can further include an eye model, wherein the eye model comprises a posterior segment and an anterior segment. The posterior segment and the socket housing can include cooperating engagement structure for engaging the posterior segment to the socket housing.

The eye model engagement structure can include a biased engagement head. The eye model engagement structure can include a force sensing engagement head. The eye model engagement structure can include a pneumatic force-applying engagement head. The eye model engagement structure can include a pivoting semispherical engagement head.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a perspective view of an eye model system according to the invention.

FIG. 2 is a perspective view of an eye model system according to the invention, partially disassembled.

FIG. 3 is a bottom perspective view.

FIG. 4 is a top plan view.

FIG. 5 is a cross-section taken along line 5-5 in FIG. 4.

FIG. 6 is a top plan view of an eye model system, with an eye model inserted into a socket housing.

FIG. 7 is a cross-section taken along line 7-7 in FIG. 6.

FIG. 8 is an exploded perspective.

FIG. 9 is a perspective view partially in cross-section.

FIG. 10 is an enlarged depiction of area 10 in FIG. 9.

FIG. 11 is an enlarged depiction of area 11 in FIG. 9.

FIG. 12 is a perspective view of an eye model.

FIG. 13 is a plan view.

FIG. 14 is a side elevation.

FIG. 15 is a cross-section taken along line 15-15 in FIG. 14.

FIG. 16 is an exploded perspective.

FIG. 17 is an exploded side elevation.

FIG. 18 is a cross-section taken along line 18-18 in FIG. 17.

FIG. 19 is a plan view of a first embodiment of an anterior segment.

FIG. 20 is a cross-section taken along line 20-20 in FIG. 19.

FIG. 21 is a plan view of a second embodiment of an anterior segment.

FIG. 22 is a cross-section taken along line 22-22 in FIG. 21.

FIG. 23 is a plan view of a third embodiment of an anterior segment.

FIG. 24 is a cross-section taken along line 24-24 in FIG. 23.

FIG. 25 is a plan view of a fourth embodiment of an anterior segment.

FIG. 26 is a cross-section taken along line 26-26 in FIG. 25.

FIG. 27 is a plan view of a fifth embodiment of an anterior segment.

FIG. 28 is a cross-section taken along line 28-28 in FIG. 27.

FIG. 29 is a plan view of a sixth embodiment of an anterior segment.

FIG. 30 is a cross-section taken along line 30-30 in FIG. 29.

FIG. 31 is a side elevation of an alternative embodiment of an eye model utilizing a cadaver eye model.

FIG. 32 is a cross-section taken along line 32-32 in FIG. 31.

FIG. 33 is an exploded side elevation.

FIG. 34 is a plan view of an alternative embodiment of an eye model system according to the invention.

FIG. 35 is a cross-section taken along line 35-35 in FIG. 34.

FIG. 36 is a cross section of an embodiment having flexible engagement structure.

FIG. 37 is a cross section showing alternative engagement structure.

FIG. 38 is a perspective view of an embodiment with a transparent socket housing.

### DETAILED DESCRIPTION OF THE INVENTION

An eye model system includes a socket housing having an interior cavity sized to receive an eye model, and an anterior opening communicating with the interior cavity. Engagement structure is provided for detachably engaging and securing the eye model in the interior cavity.

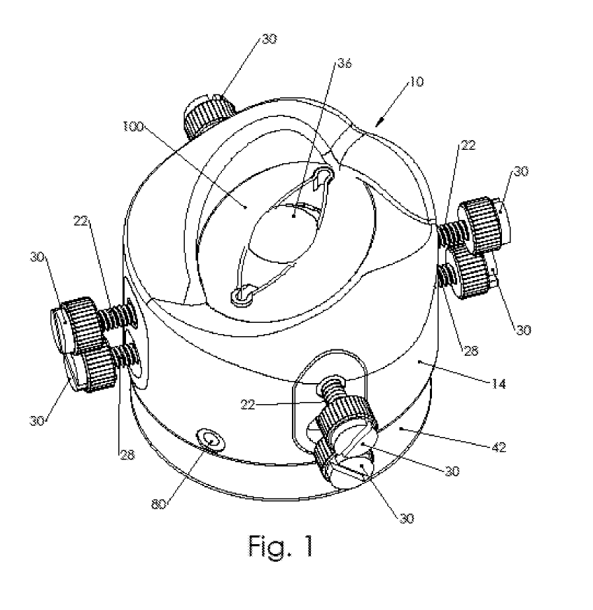

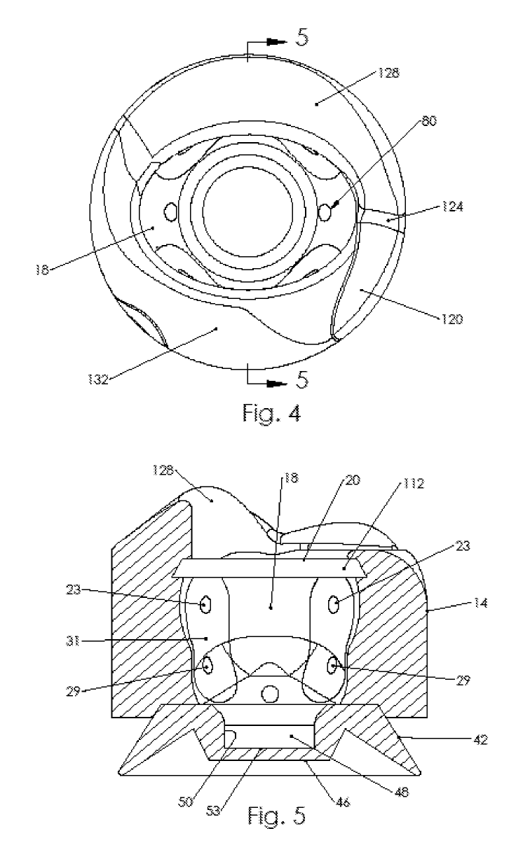

There is shown in FIGS. 1-5 an eye model system 10 according to the invention. The system 10 includes a socket housing 14 having an interior cavity 18 for receiving an eye model 36. Engagement structure is provided to secure the eye model 36 within the socket housing. Any suitable engagement structure can be utilized. The engagement structure can be provided at a single level or depth within the cavity 18, or at multiple levels to permit adjustment of the position of the eye model along the anterior-posterior axis of the cavity 18. In one embodiment, anterior screws 22 and posterior screws 28 can be provided and circumferentially distributed around the socket housing 14. Screw heads 30 can be provided to manipulate the anterior screws 22 and posterior screws 28 either manually or with the tool such as a screwdriver. Four anterior screws 22 and four posterior screws 28 are shown, however, more or fewer screws can be utilized and only a single level of screws is also possible. The anterior screws 22 and/or the posterior screws 28 can be used to adjustably position the eye model 36 within the socket housing 14 in three dimensions, laterally (or radially) and along the anterior-posterior axis of the socket housing 14.

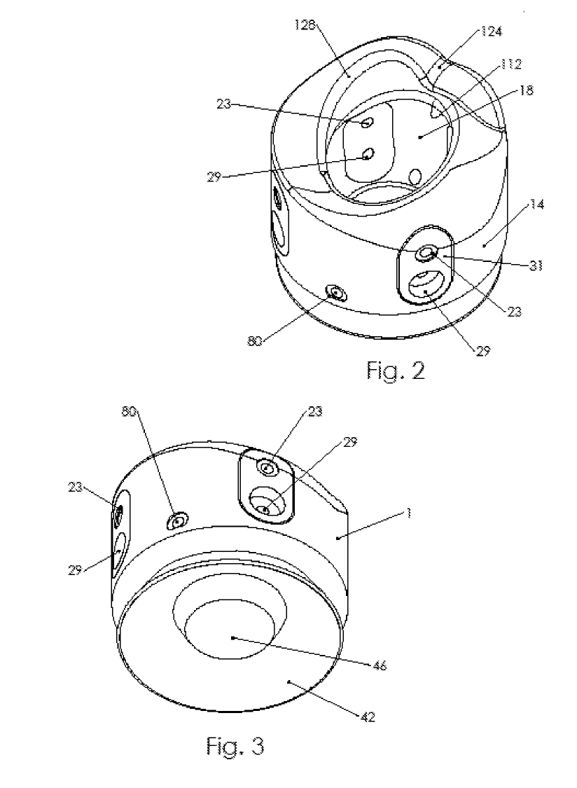

The socket housing 14 is shown in FIGS. 2-5. The socket housing 14 has an open interior cavity 18 that is dimensioned to receive the eye model 36 through an anterior opening 20. Anterior holes 23 are provided to receive anterior screws 22 and can be cooperatively threaded. Posterior holes 29 are provided to receive posterior screws 28 and can be cooperatively threaded. The anterior holes 23 and posterior holes 29 can be provided in a rigid insert 31 to lend mechanical strength around the holes for purposes of tightening the screws.

The eye model engagement structure can be laterally adjustable. Any suitable laterally adjustable engagement structure can be used, including screws, pins, solenoids, ratchets and the like. The anterior screws 22 and posterior screws 28 are radially adjustable by threading the screws radially inward or outward. The position of the eye model within the interior cavity 18 can thereby be adjusted. The eye model engagement structure can adjustably position the eye model in three dimensions within the interior cavity. The anterior radially adjustable screws 22 and posterior laterally adjustable screws 28 can be adjusted such that the position of eye model 36 can be adjusted along an anterior-posterior axis through the interior cavity 18 of the socket housing 14. Other laterally adjustable elongated members circumferentially distributed about the interior cavity of the socket housing 14 are possible, including replaceable inserts with apertures of varying dimension for engaging the eye model at different positions. The engagement structure should make at least three points of contact with the eye model for appropriate lateral engagement. Engagement structure with a mechanically variable dimensioned aperture in the manner of a camera shutter is also possible. The larger the opening created by the posterior engagement structure, the further posterior the eye model will be permitted to move, while the smaller the opening created by the posterior engagement structure the further anterior the eye model will be positioned. The anterior engagement structure then helps to fix, pressurize and retain the eye in position. The engagement structure can be level or angled posteriorly or anteriorly. Electronically controllable elongated members can be connected to solenoids to provide for electronic positioning of the eye model within the interior cavity 18 both in the radial direction and along the anterior-posterior axis. It is also possible to use other engagement structure designs, for example, circumferential engagement structure such as bands or vertically oriented bumpers or graspers, or resilient or inflatable structure such as inflatable bladders. Other suitable structure is possible.

The eye model system can have structure for engaging the socket housing 14 to a support surface. The structure for engaging the support surface can include a flexible portion for permitting tilting of the socket housing 14 relative to the support surface. The structure for engaging the support surface can be a suction cup 42. The suction cup 42 can include a central body 46 defining a recess 48 with side walls 50 and base 53. The suction cup 42 and/or the central body 46 can comprise a flexible material to permit the socket housing 14 to tilt relative to the support surface when engaged to the support surface. Other structure for engaging the support housing 14 to surface can alternatively be utilized. The support surface can be a smooth vertical surface, and the suction cup 42 can engage such surfaces. Some ophthalmological procedures are done with the patient in a seated position, and mounting on a vertical surface can facilitate the practice of such procedures.

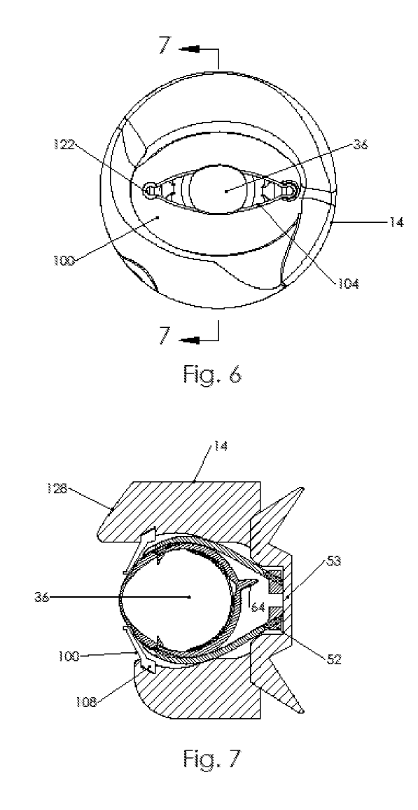

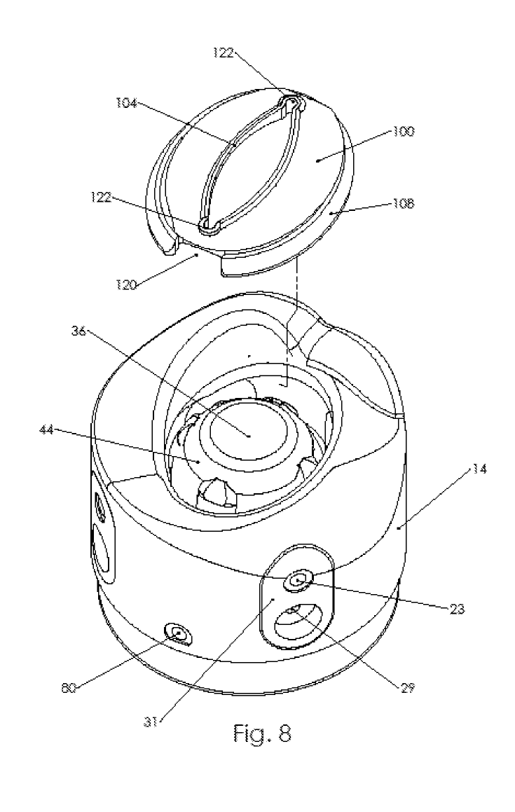

The positioning of the eye model 36 within the socket housing 14 is shown in FIGS. 6-11. The eye model 36 is positioned within the interior cavity 18 of the socket housing 14. Radially and anterior-posterior adjustable engagement structure such as anterior screws 22 and posterior screws 28 can be provided to secure the eye model 36 within the socket housing 14. Other engagement structure is possible. For example, the eye model 36 can be fitted with a base member 52. The base member 52 can be dimensioned so as to be received within cooperating engagement structure in the support housing 14, for example, the recess 48 in the central body 46 defined by walls 50. The retention can be a friction fit, an elastic engagement, a snap-in engagement, or other suitable engagement mechanism. Alternatively, the base member 52 can have open interior walls 51 defining a threaded aperture 55 for attachment of the eye model 36 to a support surface or the housing by a screw or the like. The posterior segment and/or the socket housing 14 can be connected by different securing structure such as hooks, hook and loop fasteners, pins, bosses, belt grooves or other types of attachment. The socket housing can be attached to other structures such as another instrument, test benches, face models or other surgical models.

Other cooperating engagement structure is possible. A cover 100 can be provided to retain the eye model 36 in the cavity 18 of the socket housing 14. The cover 100 can be made of a flexible material which will somewhat conform to the shape and position of the eye model 36 while retaining the eye model 36 in position. Suitable engagement structure such as snap-ring 108 can be provided on the cover 100 for engaging the cover 100 to the socket housing 14. The socket housing 14 can be fitted with a groove 112 for receiving the snap-ring 108 and thereby securing the cover 100 to the socket housing 14. A snap-ring gap 120 can be provided to allow for squeezing the snap-ring 108 to reduce the diameter of snap-ring 108 when positioning the snap-ring 108 in the groove 112. Port holes or openings 80 can be provided to drain or supply fluids from and to the socket housing 14. The detachable cover can have an opening in the form of a circle or slit 104, from which a portion of the anterior segment can protrude to the exterior.

The anterior portion of the socket housing can include a simulation of at least one selected from the group consisting of the frontal bone, the nasal bone, the maxilla bone and the zygomatic bone. Structure can be provided with the socket housing 14 to mimic such anatomical structures, for example the nose 120, bridge 124, brow 128 and cheek 132. The cover 100 can be shaped to resemble a biological eye lid to provide realism for practicing a medical procedure. The eyelid opening or slit 104 can be provided to permit access to the eye model 36 and to also provide realism to the model. An eye corner 122 can be simulated for additional realism.

The eye model system can include one or more interchangeable eye models 36, and of differing designs. In one embodiment, at least a portion of the eye model is synthetic. In another embodiment, at least a portion of the eye model is biological. A combined biological-synthetic eye model is also possible. The eye model can be constructed for the particular medical procedure that will be practiced.

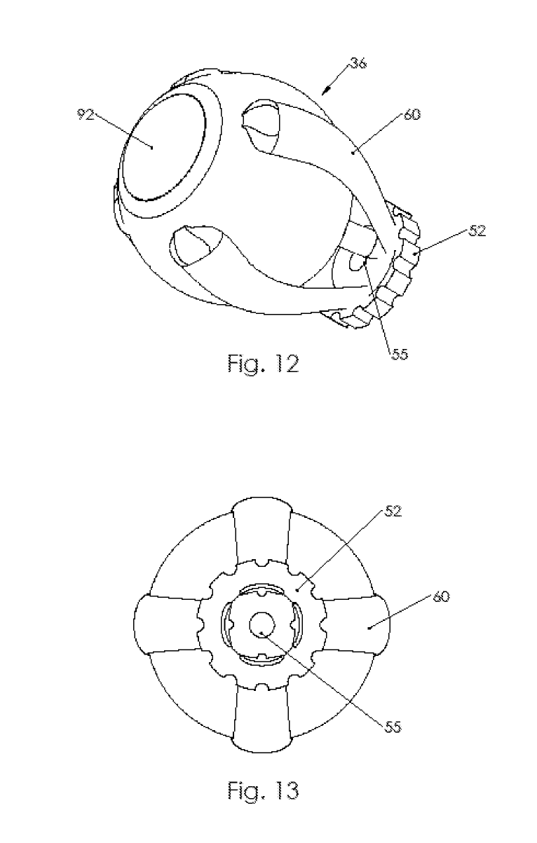

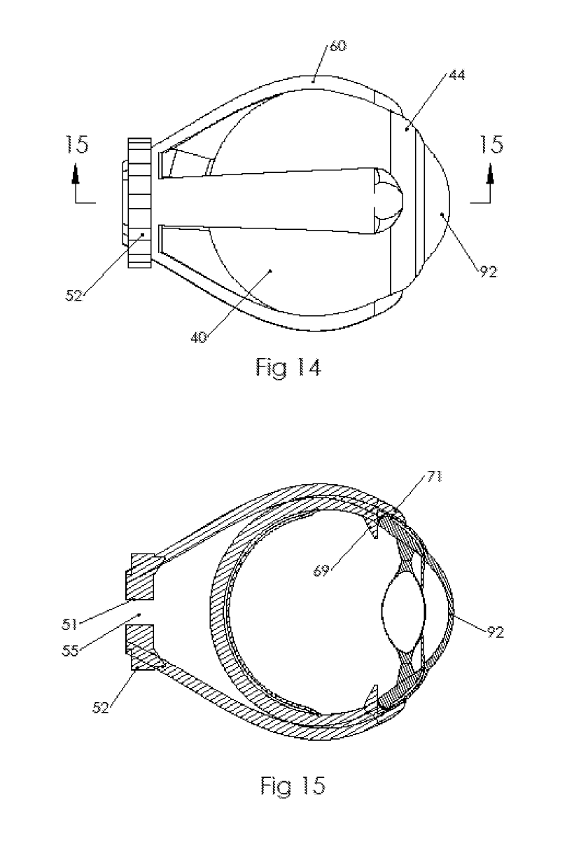

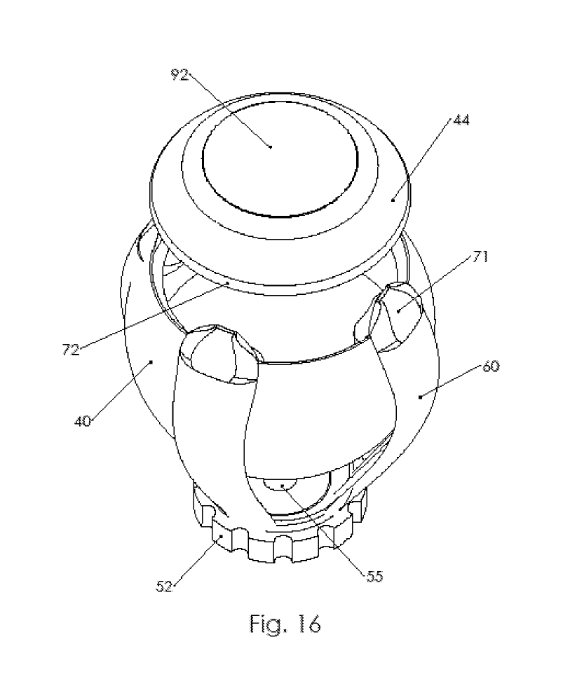

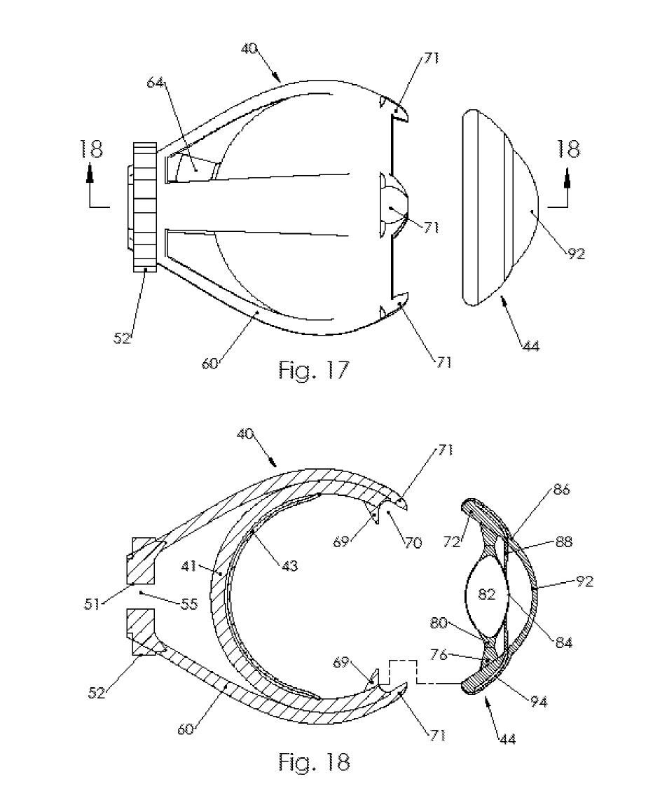

An eye model 36 that is suitable for the invention is shown in FIGS. 12-18. The eye model 36 can have a base 52 as previously described. Various anatomical features such as muscles 60 and the optic nerve 64 can be provided to lend visual, spatial and mechanical realism to the eye model 36. The eye model 36 can be monolithic or can be formed from various detachable parts. There is shown in the drawings an eye model 36 having a posterior segment 40 and an anterior segment 44. The posterior segment 40 can have a posterior sclera region 41, a retinal layer 43, base 52, elongated connectors 60 simulating muscles, and optic nerve 64. One or both of the posterior segment 40 and anterior segment 44 can have engagement structure for detachably engaging the anterior segment 44 to the posterior segment 40. In one aspect, the posterior segment 40 can have an engagement groove 70 formed by interior limit 69, which limits the anterior segment 44 posteriorly, and muscle insertion 71 which retains the anterior segment 44 against anterior movement. A cooperating part of the sclera 72 of the anterior segment 44 engages within the groove 70.

The anterior segment 44 can include one or more representations of the following biological eye structures of the anterior eye anatomy: the anterior sclera, the conjunctiva, the limbus, the cornea, the lens cortex, the lens capsule, the zonule, the ciliary body, Schlemm's canal, the trabecular meshwork, the iris, the sulcus, the anterior hyaloid membrane. The anterior segment 44 can as shown in the drawings have a sclera 72 represented. The sclera 72 can be connected to a ciliary body 76. A zonule 80 connects the ciliary body 76 to a lens capsule 84 which envelopes a lens cortex 82. An iris 88 is provided anterior to the lens capsule 84 and is covered by a cornea 92 which is connected to the sclera 72 at the limbus 86. A conjunctiva 94 can be positioned over the sclera 72 and connected to the cornea at the limbus 86. Additional features to simulate abnormalities of the eye for purposes of the medical procedure can also be introduced.

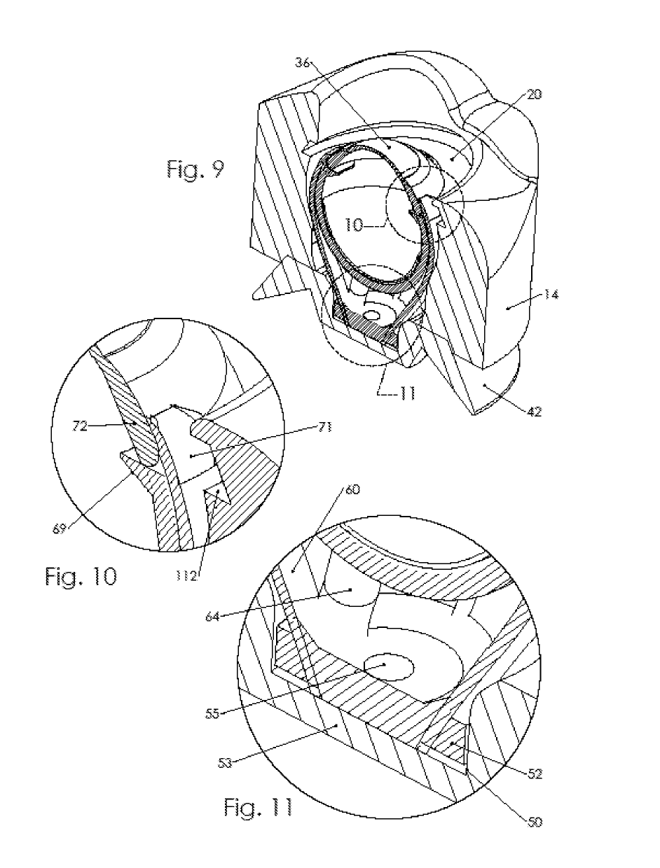

The manner in which the anterior segment 44 is engaged to the posterior segment 40 can vary. As shown in FIG. 10 the sclera 72 can fit between the interior limit 69 and muscle insertion 71 of the posterior segment 40 to engage the anterior segment 44 to the posterior segment 40. The engagement should include at least two muscle insertions 71 for a secure engagement. Other engagement structure is possible, such as glues, for example. Cyanoacrylate glues work well on eye tissue, and will also bond to plastics

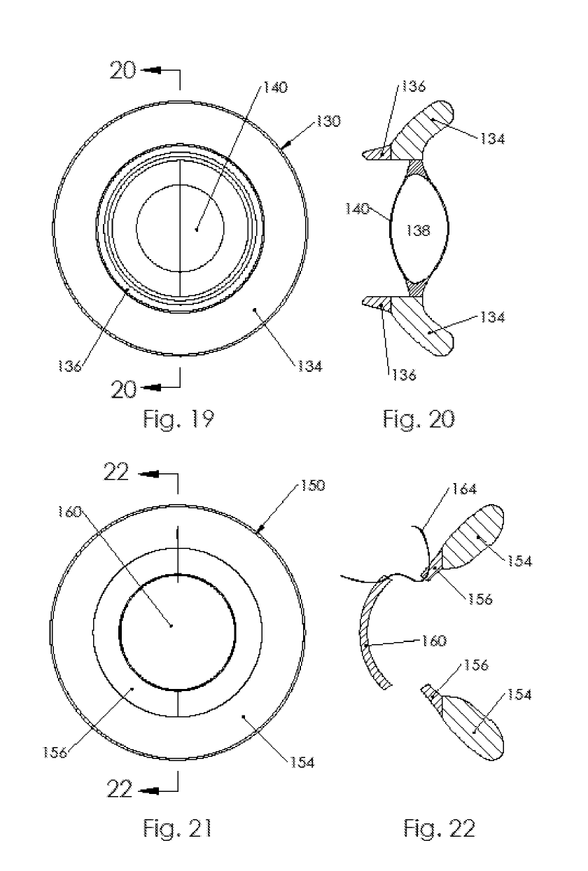

The anterior segment 44 can be customized for the procedure that will be practiced, by combining the minimum structures required to form a model suitable for practicing a desired procedure. Such a customized anterior segment can be mounted to the posterior segment as described. Some possible customized anterior segments are disclosed herein, but the invention is not limited to these customizations and others are possible. There is shown in FIGS. 19-20 an anterior segment 130 of a rhexis model having a sclera 134, a limbus 136, and an anterior capsule 140 enveloping a lens cortex 138. The rhexis model 130 is useful to practice creating incisions on the limbus 136, creating a circular tear on the anterior capsule 140, and removing the capsule contents (lens cortex) 138.

There is shown in FIGS. 21-22 a corneal suturing model 150 having sclera 154, limbus 156, and cornea 160. The corneal suturing model 150 is useful for practicing the suturing of the cornea 160 on the limbus 154 with a suture 164.

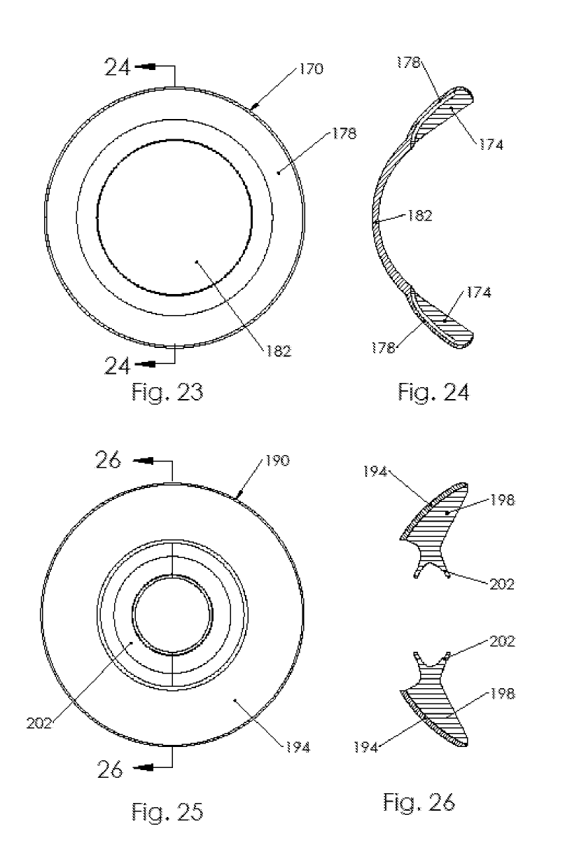

There is shown in FIGS. 23-24 a shunt model 170 having a sclera 174, conjunctiva 178 and cornea 182. The shunt model 170 is useful for practicing the guiding of a cannula between the conjunctiva 178 and sclera 174 into the anterior chamber of the eye.

There is shown in FIGS. 25-26 an intra ocular lens (IOL) mounting model 190 having a hard sclera 194, an elastic ciliary body 198, and a zonule feature 202 to engage the lens. The IOL model 190 provides structures that allow placement of an intra-ocular lens for practice, or to add optical elements to the model, which could be of use to simulate laser procedures on the retina of a posterior segment model. The zonule feature 202 can also allow the placement of explanted biological lenses to practice procedures requiring biological tissue.

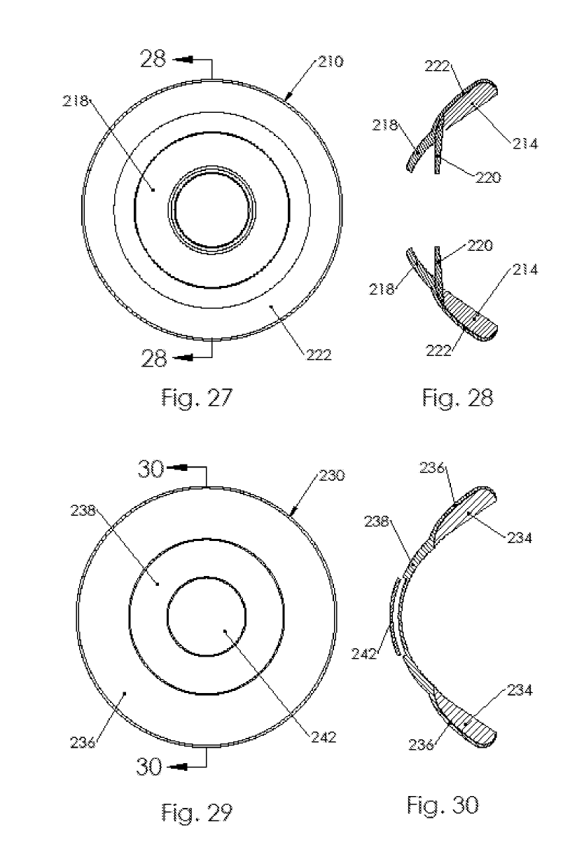

There is shown in FIGS. 27-28 an angle model 210. The angle model 210 has a sclera 214, limbus 218, iris 220 and conjunctiva 222. The angle model 210 simulates the corneal angle between the cornea and iris to perform trabeculectomy-type procedures, and permits practice of the iridotomy/iridectomy procedures.

There is shown in FIGS. 29-30 a lamellar keratoplasty model 230 having a sclera 234, conjunctiva 236, cornea 238 and lamellar graft 242. The lamellar keratoplasty model 230 permits practicing of different anterior and posterior lamellar corneal transplant techniques such as DALK, DLEK, DSEK, and DMEK.

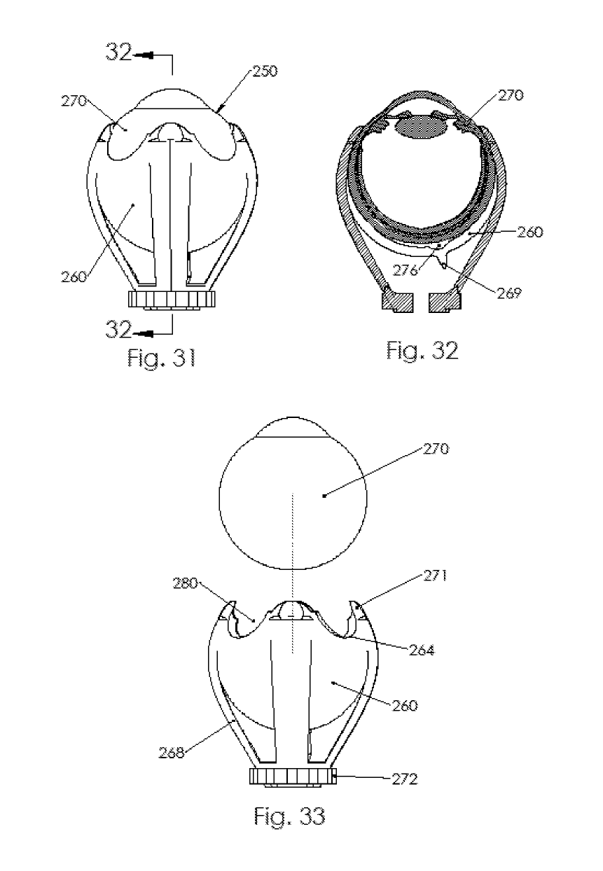

The posterior segment can have structure for detachably engaging a portion of the anterior segment. In one embodiment the posterior segment has a portion for receiving a portion of the anterior segment. The posterior segment can be synthetic and have a receptacle with an anterior opening for receiving a biological eye model. There is shown in FIGS. 31-33 an embodiment of such a combined biological-synthetic eye model 250. The posterior segment 260 is synthetic. The anterior segment 270 can be synthetic or a biological eye model obtained from a cadaver. The posterior segment 260 can have synthetic structures mimicking biological structures such as muscles 268 and optic nerve 269. The posterior segment 260 can define a receptacle 276 having an anterior opening 280 for receiving the cadaver eye 270. The receptacle 276 can provide a mechanical, elastic, adhesive or frictional engagement of the cadaver eye 270 to the receptacle 276. A relief 264 can be provided between muscle insertions 271. Base 272 can be utilized to secure the posterior segment 260 to the socket housing 14. The cadaver eye 270 will thereby be securely retained within the posterior segment 260 and the socket housing 14 to facilitate the practice of medical procedures on a biological eye model. This provides a number of advantages over the current practice with biological eye models, which are wet and round and therefore difficult to secure in position for the practice, and also lack structures such as muscles, and reference structures such as the brow and nose.

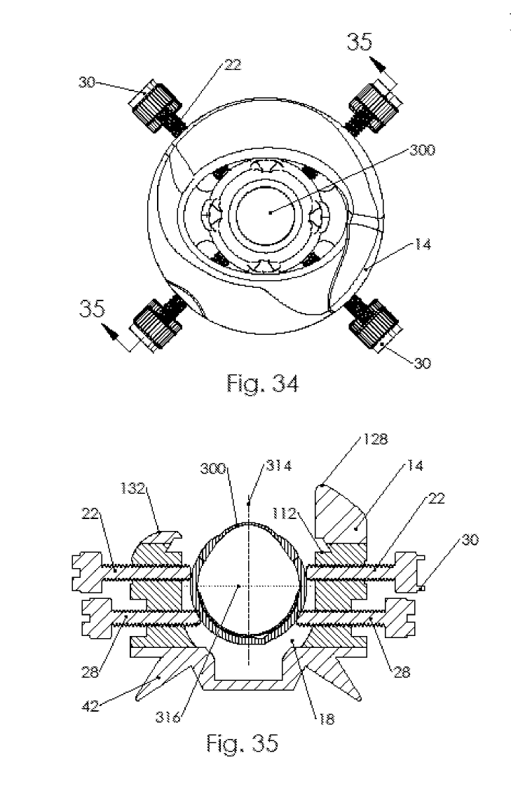

There is shown in FIGS. 34-35 an embodiment that is useful for mounting a synthetic or cadaver eye model 300. A socket housing 14 as described can be provided and can receive the eye model 300 in the interior cavity 18. Engagement structure such as anterior screws 22 and posterior screws 28 are radially adjusted using heads 30 to secure the eye model 300 along the posterior-anterior axis 314 through the cavity 18, as well as laterally through the radial positioning along a radial axis 316 perpendicular to the posterior-anterior axis 314 by adjustment of the screws 22 and 28 about the circumference of the socket housing 14. In this manner, the position of the eye model 300 can be adjusted in three dimensions.

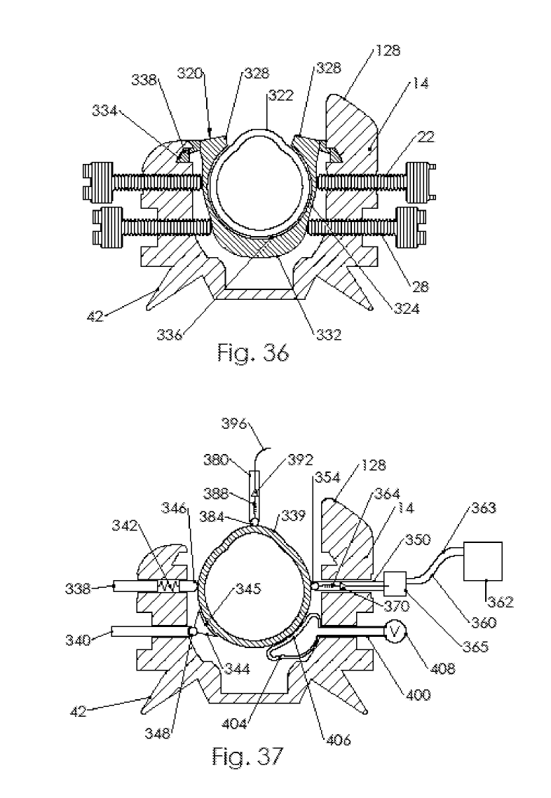

FIG. 36 illustrates an embodiment of the invention which provides a flexible pouch 320 securing the eye model 322. The flexible pouch 320 elastically engages the eye model 322 to provide a secure engagement while distributing the force that is used to engage the eye model 322. The flexible pouch 320 can include sidewall portions 324 and a base portion 332 for defining a receptacle 336 which is sized to receive the eye model 322. The receptacle 336 can be slightly smaller than the eye model 322 such that some deformation of the flexible pouch 320 will occur when the eye model 322 is pressed into the receptacle 336, such that the eye model 322 will be elastically engaged. The anterior portions 328 of the flexible pouch 320 can define an anterior opening for the receptacle 336 that is smaller than the largest diameter of the eye model such that the anterior portions 328 of the sidewall portions 324 extend around the midpoint of the eye model 322 so as to partially envelop the eye model 322. The flexible pouch 320 can be detachably secured within the socket housing 14 by suitable structure. In the embodiment that is shown a rim 338 is formed in the flexible lining 324 and detachably engages a cooperating groove 334 in the socket housing 14. The flexible pouch 320 can be used with additional structure for engaging the eye model 322, such as anterior screws 22 and posterior screws 28. The flexible lining can also be permanently secured or fashioned into the socket housing 14.

There is shown in FIG. 37 an embodiment having alternative engagement structure for securing the eye model 339. Biased engagement structure 338 includes a biasing such as spring 342 to bias the engagement head 346 against the eye model 339. The spring force of the spring 342 can be selected for the amount of pressure that is desired for the eye model 339. A semi-spherical engagement structure 340 can be provided with an engagement head 344 having a semi-spherical engagement surface 345 which will distribute the pressure applied to the eye model 339 across the surface of the semi-spherical engagement surface 345 of the engagement head 344. The engagement head 344 can be pivotally mounted about a pivot 348 to facilitate appropriate alignment of the semispherical engagement surface 345 with the cooperating semispherical surface portion of the eye model 339.

A force-sensing engagement structure 350 has a force-sensing engagement head 354 connected to spring 364 and sensor electronics 370 for supplying a force signal through connection 360. The connection 360 can be wired or wireless and can communicate with a processor 362 for adjusting the force applied by the force sensing engagement structure 350, as by a solenoid 365 depending on the force sensed at the head 354 and communicated to the solenoid 365 by a solenoid control connection 363. The sensor 370 can be used to monitor the pressure in the eye model 339. This can be useful particularly in biological eye models where the eye pressure can be variable depending on the condition and age of the cadaver model. Appropriate feedback can be provided between the force-sensing structure and force applying structure such as a solenoid 365 to adjust the pressure of the eye model 339 to a desired level. The force sensor can be independent of the engagement structure as shown by the force sensor 380. The force sensor 380 has a force sensing head 384 a force spring 388 and sensor electronics 392 and communication connection 396 for communicating with a processor such as the processor 362.

An alternative embodiment utilizes a pneumatic force applying engagement structure 400. The force applying engagement structure 400 has a pneumatic engagement head 404 for presenting a flexible engagement surface 406 to the eye model 339. A source of pressurized fluid 408 can be a pump or other suitable source for providing a variable pressure supply of fluid. The pressure applied to the eye model 339 will be a function of the pressure within the pneumatic engagement head 404. Feedback to the source of the pressurized fluid can be provided as from the eye model pressure sensor 380 and a suitable processor such as the processor 362, which in this embodiment would provide feedback to a pump or control valve or other pressure control feature for controlling the pressure within the pneumatic engagement head 404 and thereby the pressure within the eye model 339.

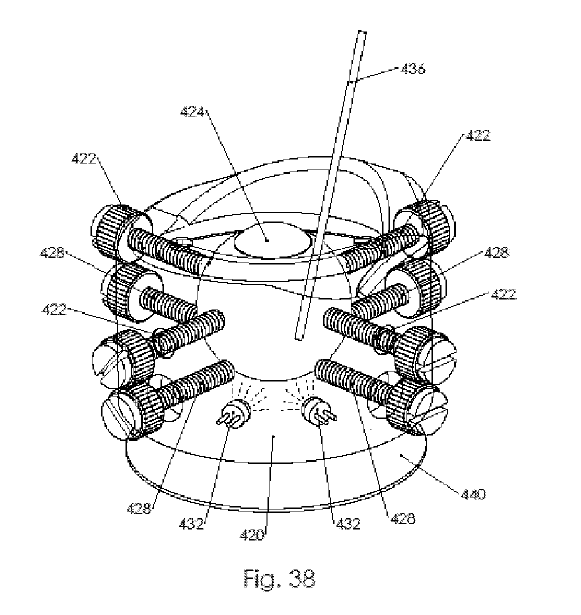

Still another embodiment is shown in FIG. 38 in which the socket housing 420 is made of a transparent or translucent material in order to permit the user to visualize the position of the eye model 424 that is positioned within the socket housing 420. The entire socket housing 420 can be made transparent or portions thereof to provide windows to the inside. In particular, a hypothetical instrument 436 can then be visualized for purpose of practice and instruction of the procedure. The eye model 424 can be secured by any suitable engagement structure such as anterior screws 422 and posterior screws 428. Structure to secure the socket housing 420 to a surface can be provided, such as suction cup 440. Lights 432 can illuminate the interior cavity and the eye model 424 to facilitate viewing the procedure through the transparent socket housing 420 and/or the eye model if it is transparent or translucent. External lights can alternatively be utilized.

The eye model system can further include structure for applying an adjustable force to the eye model, so as to adjust the intra ocular pressure within the eye model. A sensor can be provided for sensing the intra ocular pressure.

The dimensions of the socket housing 14 and the eye model 36 can vary. The socket housing can have any suitable size and shape. In one aspect the socket housing 14 is cylindrical and has a diameter and a height between 1.5 and 3.5 inches, or about 2 inches. The dimensions of the interior cavity will change with the dimensions of the largest eye model that is selected but for many applications a cavity fitting a sphere with a diameter of between 15 mm to 30 mm will be suitable. The dimensions of the eye model can vary, and the adjustable engagement structure can be used to engage eye models having different dimensions. In the case of a biological model it will depend on the size of the specimen that may be available, and whether the eye model is human, primate, pig, rabbit, cow or other species. In the case of a synthetic model it can vary depending upon the procedure that will be practiced, for example, a procedure for infant eyes will require a smaller eye model to be realistic

The materials from which the components of the invention are made can vary. High grade synthetic materials can be used. It is possible to manufacture the eye models, socket housing, and other components of the invention with casting, molding or 3D printing technology. The materials can be flexible. A flexible body 14 has some ergonomic advantages to the user such as flexibility that will assist in engaging the eye model to the socket housing, and also to provide an element of realism by mimicking the give of a biological eye in response to external forces, without the need for springs or moving parts; and at the same time allowing rigid members to engage the eye securely. Once the eye model is engaged, the flexibility of the body 14 enables the simulation of the give of the biological eye under external forces. The natural eye is nested in fat, and can be displaced by an external force. Once this force is removed, the fat recoils and the eye is returned to its original position. The flexible material to which the engagement members are attached, either directly or through a rigid insert 31 that is in communication with flexible material, replicates this action of natural fat. The material making up the socket housing can comprise, by volume of the material, over 50% flexible material, or over 60%, 70%, 80%, 90%, or 95% flexible material. Permits the engagement members such as screws to move without having movable parts themselves. Other structure for providing this yield or give effect, such as biased (spring) mountings for the engagement members, is also possible.

A method for practicing medical procedures of the eye includes the step of providing an eye model system including a socket housing having an interior cavity sized to receive an eye model, and an anterior opening communicating with the interior cavity. Engagement structure is provided for detachably engaging and securing the eye model in the interior cavity. An eye model is provided. The eye model is positioned within the interior cavity and secured with the engagement structure. The medical procedure is then practiced.

The eye model engagement structure can be used to adjustably position the eye model in three dimensions within the interior cavity, and the method can further include the step of adjusting the position of the eye model within the interior cavity. The eye model can include a plurality of anterior segments and at least one posterior segment, and the method can further include the step of selecting the anterior segment from the plurality based upon the medical procedure that will be practiced, and engaging the selected anterior segment to the posterior segment.

The method can include the step of sensing the intra ocular pressure of the eye model, and applying a force to the eye model to adjust the intra ocular pressure. The force can be applied by the eye model engagement structure, or by a separate force-applying structure.

Ranges: throughout this disclosure, various aspects of the invention can be presented in a range format. It should be understood that the description in the range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range for example, 1, 2, 2.7, 3, 4, 5, 5.3 and 6. This applies regardless of the breadth of the range.

This invention can be embodied in other forms without departing from the spirit or essential attributes thereof, and accordingly, reference should be had to the following claims to determine the scope of the invention.

We claim:

1. An eye model system, comprising:
an eye model comprising a posterior segment and an anterior segment, the anterior segment and the posterior segment being detachably connectable, the posterior segment comprising an elongated connector having a posterior end;
a base attached to the posterior end of the elongated connector; and,
a socket housing having an interior cavity sized to receive the eye model, an anterior opening communicating with the interior cavity, and cooperating engagement structure for engaging the base.

2. The eye model system of claim 1, wherein the socket housing comprises a receptacle, the base and the receptacle mating to secure the posterior segment to the socket housing.

3. The eye model system of claim 1, wherein the posterior segment has structure for receiving a portion of the anterior segment.

4. The eye model system of claim 1, wherein the posterior segment comprises a semispherical receptacle having an anterior opening for receiving the anterior segment.

5. The eye model system of claim 4, wherein the anterior segment is a biological eye.

6. The eye model system of claim 1, wherein at least the anterior segment of the eye model is synthetic.

7. The eye model system of claim 1, wherein at least the anterior segment of the eye model is biological.

8. The eye model system of claim 1, wherein the socket housing comprises fluid port openings.

9. The eye model system of claim 1, further comprising a detachable cover for engaging the socket housing and retaining the eye model within the interior cavity.

10. The eye model system of claim 1, wherein an anterior portion of the socket housing comprises a simulation of at least one selected from the group consisting of the frontal bone, the nasal bone, the maxilla bone and the zygomatic bone.

11. The eye model system of claim 1, wherein the socket housing comprises a flexible material.

12. The eye model system of claim 1, wherein the elongated connector is flexible, whereby the posterior segment will yield under manual force.

13. The eye model system of claim 1, further comprising structure for applying an adjustable force to the eye model, so as to adjust the intra ocular pressure within the eye model.

14. The eye model system of claim 13, further comprising a sensor for sensing the intra ocular pressure.

15. The eye model system of claim 1, further comprising structure for engaging the socket housing to a support surface.

16. The eye model system of claim 15, wherein the structure for engaging the support surface comprises a flexible portion for permitting tilting of the socket housing relative to the support surface.

17. The eye model system of claim 1, wherein the socket housing comprises a transparent portion for viewing a medical procedure as it is practiced.

18. The eye model system of claim 1, wherein the socket housing comprises lighting for illuminating the eye model.

19. A method for practicing medical procedures of the eye, comprising the steps of:
providing an eye model system comprising a socket housing having an interior cavity sized to receive an eye model, an anterior opening communicating with the interior cavity, and engagement structure for detachably engaging and securing the eye model in the interior cavity;
providing an eye model, and positioning the eye model within the interior cavity; and,
practicing the medical procedure.

20. The method of claim 19, wherein the eye model engagement structure adjustably positions the eye model in three dimensions within the interior cavity, and further comprising the step of adjusting the position of the eye model within the interior cavity.

21. The method of claim 19, wherein the eye model comprises at least one anterior segment and at least one posterior segment, and further comprising the step of engaging the anterior segment to the posterior segment.

22. The method of claim 21, wherein the eye model comprises a plurality of anterior segments, and further comprising the steps of selecting a medical procedure that will be practiced and selecting the anterior segment from the plurality based upon the medical procedure that is selected, and engaging the selected anterior segment to the posterior segment.

23. The method of claim 19, further comprising the step of sensing the intra ocular pressure of the eye model, and applying a force to the eye model to adjust the intra ocular pressure.

24. The method of claim 23, wherein the force is applied by the eye model engagement structure.

25. A socket housing for securing an eye model, comprising:
an interior cavity sized to receive an eye model, and an anterior opening communicating with the interior cavity;
engagement structure for detachably engaging and securing the eye model in the interior cavity; and
a flexible portion for permitting the engagement structure to move upon the application of a force to the eye model.

26. The socket housing of claim 25, wherein the eye model engagement structure is attached to a rigid portion of the socket housing, the rigid portion communicating with the flexible portion such that a force on the engagement structure will be transmitted to the rigid portion and thereby to the flexible portion, causing the flexible portion and thereby the rigid portion and the engagement structure to yield under the force.

27. The socket housing of claim 25, wherein the eye model engagement structure is laterally adjustable.

28. The socket housing of claim 27, wherein the eye model engagement structure comprises laterally adjustable elongated members circumferentially distributed about the interior cavity of the socket housing.

29. The socket housing of claim 25, wherein the eye model engagement structure adjustably positions the eye model in three dimensions within the interior cavity.

30. The socket housing of claim 29, wherein the engagement structure comprises anterior laterally adjustable engagement structure and posterior laterally adjustable engagement structure.

31. The socket housing of claim 25, further comprising an eye model, wherein the eye model comprises a posterior segment and an anterior segment.

32. The socket housing of claim 31, wherein the posterior segment and the socket housing comprise cooperating engagement structure for engaging the posterior segment to the socket housing.

33. A socket housing for an eye model, comprising:
an interior cavity sized to receive the eye model, and an anterior opening communicating with the interior cavity;
laterally adjustable eye model engagement structure for detachably engaging and securing the eye model in the interior cavity; and
wherein the engagement structure comprises posterior engagement structure for limiting posterior movement of the eye mode, and anterior engagement structure for limiting anterior movement of the eye model.

34. The socket housing of claim 33, wherein the eye model engagement structure comprises laterally adjustable elongated members circumferentially distributed about the interior cavity of the socket housing.

35. The socket housing of claim 33, wherein the eye model engagement structure adjustably positions the eye model in three dimensions within the interior cavity.

36. The socket housing of claim 33, wherein the engagement structure comprises anterior laterally adjustable engagement structure and posterior laterally adjustable engagement structure.

37. The socket housing of claim 33, further comprising an eye model, wherein the eye model comprises a posterior segment and an anterior segment.

38. The socket housing of claim 37, wherein the posterior segment and the socket housing comprise cooperating engagement structure for engaging the posterior segment to the socket housing.

39. The socket housing of claim 33, wherein the eye model engagement structure comprises a biased engagement head.

40. The socket housing of claim 33, wherein the eye model engagement structure comprises a force sensing engagement head.

41. The socket housing of claim 33, wherein the eye model engagement member comprises a pneumatic force-applying engagement head.

42. The socket housing of claim 33, wherein the eye model engagement structure comprises a pivoting semispherical engagement head.
